(19) United States
(12) Patent Application Publication
(10) Pub. No.: US 2008/0193789 A1
(43) Pub. Date: Aug. 14, 2008

(54) Use of Surface-Modified Particles in Electroplating Technology

(75) Inventor: Jan Steinbach, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, Munchen (DE)

(21) Appl. No.: 11/664,566

(22) PCT Filed: Sep. 16, 2005
(86) PCT No.: PCT/EP05/54608

§ 371 Date: Apr. 3, 2007

(30) Foreign Application Priority Data
Oct. 4, 2004 (EP) 04023599.6

(51) Int. Cl. B32B 15/04; B22F 1/02

(52) U.S. Cl. 428/552; 427/212

(57) ABSTRACT

The invention relates to the use of surface-modified particles in electroplating technology, to a method for their production and to said particles.

### CROSS REFERENCE TO RELATED APPLICATIONS

This application is the US National Stage of International Application No. PCT/EP2005/054608, filed Sep. 16, 2005 and claims the benefit thereof. The International Application claims the benefits of European application No. 04023599.6 filed Oct. 4, 2004, both of the applications are incorporated by reference herein in their entirety.

### FIELD OF INVENTION

The invention relates to the use of surface-modified particles in electroplating technology, to a method for their production and to the particles themselves.

### BACKGROUND OF THE INVENTION

Particles of metals, semimetals, alloys of metals and/or semimetals as well as compounds of metals or semimetals play an important role in many industrial processes, for example electroplating. For many of these applications, particles are required with an average particle size of from about 0.1 μm to about 1 μm (so-called sub-microscale particles) and sometimes with particle sizes of less than 100 nm (so-called nanoscale particles).

Methods for producing such highly disperse powders are well known to the person skilled in the art. However, considerable problems are encountered when storing and/or processing these highly disperse powders. For particles in the sub-microscale or nanoscale range which readily form passivation layers, for example alloys with a high chromium content, although the formation of an outer oxide layer can increase the storage stability, precisely this oxide layer may be a hindrance for further processing. In many applications, such as in various electroplating methods, the removal of this oxide layer during the last processing steps represents a considerable technical problem which has not yet been resolved satisfactorily.

In the case of powders which do not themselves form a passivating oxide layer despite having a high affinity for (air) oxygen, for example finely disperse CrAl—XYZ powders (where X, Y and Z stand for conventional secondary alloy elements) and metal alloy powders with the base metals titanium, zirconium, vanadium, molybdenum and tungsten, as well as in the case of powders which show little affinity for oxygen and have only little or no susceptibility to forming a passivation layer, for example finely disperse NiCo—XYZ powders (where X, Y and Z stand for conventional secondary alloy elements) and metal alloy powders with the base elements iron, tantalum, niobium, platinum and palladium, it is found that their unmodified storage often cannot be guaranteed satisfactorily and their processability turns out to be difficult. For instance, the specific surface of the powders increases with a decreasing particle size, which can lead to undesired reactions or modifications of the surface especially with a view to their subsequent use. The aggregation of small particles to form larger aggregates is also observed, which can likewise compromise their further processability for example because it is often not or only limitedly possible to re-disperse these aggregates to the original particle size.

Methods have been proposed in the prior art for modifying the surfaces of such powders of reactive materials having a small particle size with the aid of organic compounds, for example in order to suppress aggregation of the powder particles. For instance, German patent application DE 195 15 820 A1 describes a method in which amorphous or semicrystalline nanoscale particles for the production of glass or ceramic are modified with at least one surface-blocking substance. The surface-blocking substances may inter alia be emulsifiers or nonionic surfactants. DE 195 15 820 A1 does not teach the use of the ceramic powders producible according to this method in electroplating technology.

The organic compounds proposed in the prior art for modifying the particle surface have a perturbing effect—similarly as a passivating oxide layer—especially on the final processing in electroplating technology and must be removed beforehand by burning, thermal decomposition or by means of chemical reactions.

### SUMMARY OF INVENTION

It is therefore an object of the present invention to provide disperse particles for use in electroplating technology, which on the one hand are sufficiently storage-stable and on the other hand can be readily-processed in electroplating technology method steps.

This object is achieved according to the invention by the use of surface-modified particles in electroplating technology, the surface of which is modified with at least one surface- or interface-active substance so that a shell layer is formed.

### DETAILED DESCRIPTION OF INVENTION

The inventive use of the particles modified with at least one surface- or interface-active substance in electroplating technology imparts good storage stability to the disperse powders. The at least one surface- or interface-active substance forms a shell layer around each particle of the powder and thus over a long time prevents undesired chemical or physical modification of the powder, for instance due to reaction with air oxygen or aggregation. At the same time, the inventive use also allows unimpaired further processing of the powder in electroplating technology methods, because the shell layer of the at least one surface- or interface-active substance can readily be removed without leaving residues, or does not have a perturbing effect on these methods.

In the present invention, it is preferable to use particles which have an average particle size of not more than about 1 μm. The average particle size in one particularly preferred embodiment is from about 1 μm to about 0.1 μm (i.e. the particles are sub-microscale particles). In a second particularly preferred embodiment of the invention, the particles are nanoscale particles with an average particle size in a range of from about 1 nm to about 100 nm. The particle size in this case refers to the particles without a shell layer of at least one surface- or interface-active substance.

The surface-modified particles are preferably particles of metals or semimetals, which are preferably employed in electroplating technology for the coating of workpieces. Metals and semimetals selected from the group comprising Ni, Cr, Co, Fe, Al, Ti, Zr, Mn, Mo, W, Hf, V, Ta, Nb, Pd and Pt are particularly preferred.

The particles of metals or semimetals—neglecting the surface-modifying shell layer—may be present in elementary form, for example as nickel powder, in the form of alloys, for example as powders of chromium-aluminum alloys with the base composition CrAl—XYZ, where X, Y and Z stand for secondary alloy elements which are suitable for high-temperature materials or coatings, in particular Re, Y, Si, Ti, Ta, W, Mn, Mo, Nb, Zr, Hf, and specifically in conventional quantities or quantity ratios, or as chemical compounds of metals or semimetals. In the latter case oxide, nitride, carbide or boride compounds and mixed compounds thereof of metals or semimetals are preferred. The particles of metals or semimetals are particularly preferably present in elementary form or in the form of alloys.

The at least one surface- or interface-active substance, which forms the shell layer of the particles used according to the invention, may be any conventional surfactant or wetting agent. It is possible to use more than one surface- or interface-active substance, for example two, three or four different substances of this type, although it is preferable to use only one surface- or interface-active substance in each case.

Such surfactants or wetting agents are distinguished in that they reduce the interfacial tension or surface tension of a system containing them. They are (at least) bifunctional (amphiphilic) chemical compounds having at least one hydrophobic molecule part and at least one hydrophilic molecule part. The hydrophobic residue for example in hydrocarbon surfactants is a—usually linear—hydrocarbon chain having from eight to 22 carbon atoms; in siloxane surfactants, the hydrophobic residue is formed by (dimethyl)siloxane chains. The hydrophilic residue is either an electrically negatively or positively charged (hydratable) or neutral polar head group.

Without wishing to be restricted to a particular theory, it is assumed that the molecules of the at least one surface- or interface-active substance interact with the particle surface of the powder particles so that a shell layer is formed, and they thus stabilize the surface. The expression “shell layer” in the present context is not necessarily intended to mean that the surface of the particles needs to be covered fully, rather it describes the function of the surface- or interface-active substance which protects the particles modified by it inter alia against influences by air and moisture and thus substantially increases their storage stability. The precise structure of the shell layer is not known. It will depend inter alia on the nature and size of the particles as well as the specific choice of the surface- or interface-active substance.

The at least one surface- or interface-active substance is preferably a surfactant or wetting agent which is in any case used in further electroplating technology processing, for example in the pretreatment baths used therein and particularly in the process solutions or suspensions used for the metallic coating per se. In the final electroplating technology processing using the surface-modified particles, the shell layer of the surface- or interface-active substance is separated, removed or does not have a perturbing effect in the further processing steps of the electroplating technology. In electrochemical electroplating methods, for example, the medium- to long-chain molecules of the at least one wetting agent forming the shell layer may be electrostatically attracted or repelled by the polarized electrode surface via their polarized (or polarizable) regions. This leads to forces acting between the molecules and the electrodes. These can cause separation of wetting agent molecules from the particle surface or spatial alignment of the particles with difficultly separatable adsorbates toward the electrode surface. The wetting agents customary for electroplating technology form a film permeable to metal ions on the cathode surface, making it easier for them to “strip” the water dipole shells and facilitating their incorporation into the crystal structure. The wetting agent may also to a certain extent be transported into the vicinity of the cathode by the particles and compensate for losses due to electrochemically induced decomposition of the wetting agent molecules in the immediate cathode vicinity. If this surface- or interface-active substance forming the shell layer is also used as a conventional wetting agent in the electroplating technology process solution or suspension—as is preferred—then additionally perturbing effects due to this substance are not to be expected and no special precautions must be taken in order to exclude it from the process solution or suspension.

The further processing or disposal of the process solution or suspension also does not generally need to be modified or adapted.

The surface- or interface-active substance is particularly preferably selected from the group comprising hydrocarbon surfactants and siloxane surfactants (not polysiloxane surfactants). The surfactant is more particularly preferably sodium dodecyl sulfate.

Another embodiment of the invention relates to the use of the surface-modified particles in a process solution or a process suspension for electroplating, in which case before and/or during the electroplating the surface-modified particles are brought into contact with at least one substance that removes the shell layer without leaving a residue. A solvent which can dissolve the surfactant (wetting agent) forming the shell layer is selected as the substance. The removal may nevertheless also be carried out by heat treatment. The at least one wetting agent, which forms the shell layer, is however preferably selected so that it does not perturb the further electroplating technology processing of the surface-modified particles, for example because—as explained above—it forms a film permeable to the metal ions in the electric field.

In the context of the present invention, the expression “electroplating technology” is to be understood in the broadest sense and includes the treatment of metallic and nonmetallic surfaces of workpieces, intermediate, semifinished and finished products for example in order to brighten them, protect them against environmental effects, in particular corrosion and abrasion, or improve their properties in the form of composite materials.

Electroplating methods preferred here are layer application methods in which functional layers that usually substantially determine the properties of the workpiece or product, with a thickness of only a few μm are applied onto the base material the inventive use of surface-modified particles in chemical or electrochemical processes. Besides electroforming, particularly preferred here is above all electrolessly performed chemical deposition in which the (protective) metal layer is deposited on the workpiece surface to be coated after introducing (surface-modified) metal powders into a coating solution or suspension so as to form metal ions, by reducing the metal ions using chemical reducing agents without applying an external electric field, and electrochemical deposition methods (electroplating, electrodeposition, galvanizing in the strict sense) in which the metal ions formed from the metal powders in galvanizing solutions or suspensions, or charged metal alloy particles in an externally applied electric field, migrate to the workpiece connected as a cathode and are reduced there to the metal so as to form the desired protective layer or are incorporated into an existing metal or alloy matrix. In these methods, a preparatory treatment of the workpieces to be processed is necessary inter alia to degrease, pickle and activate surfaces etc. in pretreatment baths, in which surfactants or wetting agents are generally used. The treatment baths per se (process solutions or suspensions) also contain further additives, inter alia comprising surfactants and wetting agents, besides the actual coating agent and reducing agent or electrolyte. In the case of the method according to the invention, an agent for removing the surface-modified substance without leaving a residue may be added to these processing paths for the galvanizing, in so far as is necessary or desired. This agent may even be added to the pretreatment baths, when the surface-modifying substance is intended to be removed from the particles without leaving residues before the galvanizing or deposition step per se.

The present invention furthermore relates to a method for producing surface-modified particles having a shell layer of at least one surface- or interface-active substance, wherein for example the final fraction of the particle powder immediately after its production is impregnated by means of conventional methods known in the prior art (for example dispersing with ultrasound or stirring and shaking devices) with a solution of the substance(s) forming the shell layer, so that a pre-suspension of the future process solution or suspension is formed. By removing the solvent, drying etc. it is thereby also possible to obtain a powder of the now surface-modified particles. Short-chained aliphatic alcohols and other volatile organic solvents may be used as a solvent or suspending agent in this case.

The use of the surface-modified particles, which are present in a solution or suspension suitable for further electroplating technology processing, represents a further preferred embodiment of the present invention.

The invention also relates to the surface-modified particles, described above for use in electroplating technology, whose surface is modified with at least one surface- or interface-active substance so that a shell layer is formed on the particles and which are particles of metals or semimetals, wherein these particles are present in elementary form, in the form of an alloy or as oxides, nitrides, carbides, borides or as mixed compounds thereof of metals or semimetals.

The surface-modified particles according to the invention are preferably nanoscale particles or sub-microscale particles with an average particle size of from about 0.1 μm to about 1 μm. The particles are furthermore preferably particles of metals, particularly preferably of the metals Ni, Cr, Co, Fe, Al, Ti, Zr, Mn, Mo, W, Hf, V, Ta, Nb, Pd and Pt, and, more particularly preferably the metals Ni, Cr, Co and Al, particularly in elementary form or in the form of alloys. Among the inventive alloy particles with a modified surface, nickel-cobalt alloys and chromium-aluminum-XYZ alloys are particularly preferred, where X, Y and Z stand for secondary alloy elements which are suitable for high-temperature materials or coatings, in particular Re, Y, Si, Ti, Ta, W, Mn, Mo, Nb, Zr, Hf, and specifically in conventional quantities or quantity ratios. The term “CrAl—XYZ” or “chromium-aluminum-XYZ” alloy is in this case an abbreviated notation for such chromium-aluminum alloys with suitable secondary alloy elements; it is not intended either to denote the exact number of further elements besides Cr and Al—i.e. one, two, three, four or more different secondary alloy elements may be present—or to be understood as an indication of the quantitative ratios of the alloy elements with respect to one another. Examples of preferred CrAl—XYZ alloys are Cr₆₂Al₃₂YRe₅, Cr_{58.8}Al_{34.6}Y_{1.4}Re_{5.2}, Cr₇₆Al₂₁Y_{1.6}Si_{1.4}, Cr₅₇Al₄₀Y₂Si and Cr_{53.8}Al_{11.4}Ti_{11.4}Ta_{5.9}W_{8.7}Mo_{5.9}Nb_{2.8}.

Surface- or interface-active substances used for modifying the particle surface are preferably selected from the group comprising hydrocarbon surfactants and siloxane surfactants (not polysiloxane surfactants), in particular sodium dodecyl sulfate. It is furthermore preferable for the surface-modified particles according to the invention to be present in a solution or suspension, the solvent or solvent mixture used being selected so that it does not have a perturbing effect on the further electroplating treatment. Besides water, examples of suitable solvents are for example short-chained aliphatic alcohols and other volatile organic solvents.

In the context of the present invention, the terms “metal” and “semimetal” have the meanings conventional in inorganic chemistry, as explained for example in Hollemann-Wiberg, Lehrbuch der Anorganischen Chemie [textbook of inorganic chemistry] 91^{st}-100^{th} Edition, 1985, pp. 301-302 and 731-733. Examples of semimetals are in particular boron, gallium, silicon, germanium, tin, arsenic, antimony, bismuth, selenium and tellurium, while examples of metals are inter alia nickel, palladium, platinum, cobalt, iron, aluminum, chromium, titanium, manganese, molybdenum, tungsten, vanadium, niobium, tantalum, hafnium etc.

The invention will be further illustrated below by examples, which are not however intended to restrict it.

### EXAMPLES

a) Production of Surface-Modified Particles

A solution of sodium dodecyl sulfate in water is added to a finely disperse powder having an average particle size of about 1 μm with the basic composition Cr₆₂Al₃₂YRe₅, immediately after its production by means of nebulizing (or alternatively atomizing, grinding or melt spraying). The resulting suspension can be further processed directly (see Example b)); alternatively, the surface-modified particles may be obtained from the suspension by freeze drying in powder form.

b) Use of the Suspension from Example a) in Electroplating Technology

The suspension from Example a) is dispersed in an electrolytic nickel-cobalt deposition bath. The electrolytic deposition on the cathode surface leads to incorporation of the alloy powder particles into the Ni—Co layer growing on the cathode (Ni—Co matrix), while at the same time the shell layer molecules desorb from the particle surface and remain in the electrolyte suspension.

1.-13. (canceled)

14. A method of using surface-modified particles in electroplating technology, comprising:
modifying a surface of the particles with a surface- or interface-active substance such that a shell layer is formed on the particles; and
selecting the surface- or interface-active substance of the shell layer of the particles from the group consisting of: hydrocarbon surfactants, siloxane surfactants and sodium dodecyl sulfate.

15. The method as claimed in claim 14, wherein the particles have an average particle size of not more than 1 μm.

16. The method as claimed in claim 15, wherein the particles are metals or semimetals, selected from the group consisting of: Ni, Cr, Co, Fe, Al, Ti, Zr, Mn, Mo, W, Hf, V, Ta, Nb, Pd and Pt.

17. The method as claimed in claim 16, wherein the metal or semimetal particles are powders in elementary or alloy form.

18. The method as claimed in claim 16, wherein the particles are metal compounds or semimetal compounds selected from the group consisting of: oxide, nitride, carbide, boride and combinations thereof.

19. The method as claimed claim 18, wherein the surface-modified particles are present in a solution or suspension.

20. A method of producing a surface-modified particle, comprising:
providing a surface- or interface-active substance having a shell layer, the substance being in a powder form; and
impregnating a final fraction of the particle powder after production with a solution, suspension or emulsion of the substance forming the shell layer.

21. A surface-modified particle, comprising:
a particle surface; and
a shell layer formed on the surface of the particle by a surface- or interface-active substance such that the shell layer is formed on the particle, wherein the particles are metal or semimetal in the form selected from the group consisting of: elementary form, an alloy, an oxide, a nitride, a carbide, a boride and combinations thereof.

22. The particle as claimed in claim 21, wherein the particle is sub-microscale or nanoscale.

23. The particle as claimed in claim 22, wherein the particles are metals selected from the group consisting of: Ni, Cr, Co, Fe, Al, Ti, Zr, Mn, Mo, W, Hf, V, Ta, Nb, Pd and Pt.

24. The particle as claimed in claim 22, wherein the particle is a CrAl—XYZ alloy.

25. The particle as claimed in claim 24, wherein the surface- or interface-active substance of the shell layer of the particle is selected from the group consisting of: hydrocarbons surfactants, siloxane surfactants, perfluoro-hydrocarbon surfactants, and sodium dodecyl sulfate.

26. The particle as claimed in claim 25, wherein the particle is present in a solution or suspension.
